(19) United States
(12) Patent Application Publication
(10) Pub. No.: US 2023/0364509 A1
(43) Pub. Date: Nov. 16, 2023

(54) METHODS AND SYSTEMS FOR DISTRIBUTED GAMING

(71) Applicant: COMCAST CABLE COMMUNICATIONS, LLC, Philadelphia, PA (US)

(72) Inventors: Stephen Allinson, PHILADELPHIA, PA (US); Zane Vella, PHILADELPHIA, PA (US)

(21) Appl. No.: 17/744,140

(22) Filed: May 13, 2022

(51) Int. Cl. A63F 13/45; A63F 13/52; A63F 13/55; A63F 13/69

(52) U.S. Cl. CPC A63F 13/45; A63F 13/52; A63F 13/55; A63F 13/69

(57) ABSTRACT

Methods, systems, and apparatus are described herein for facilitating distributed game play incorporating smart devices. One or more device capabilities may be associated with one or more smart devices may be associated with one or more tasks. The one or more tasks may be associated with one or more game actions. One or more games may be carried out based on the one or more tasks.

### BACKGROUND

Immersive multiplayer games are rising in popularity. For example, escape room style games provide players an immersive game play experience. However, geographic disparity, social distancing, or other concerns may make it difficult for players to participate together in a fully immersive game. Further, even in AR/VR contexts, game play is traditionally limited to interacting with a single device, and thus the game play is not truly immersive (such as, for example, an escape room style game).

### SUMMARY

It is to be understood that both the following general description and the following detailed description is merely an example and is explanatory only and is not restrictive. Methods, systems, and apparatuses for distributed immersive gaming are described. In the course of participating in an online gaming session, a computing device may determine a plurality of device capabilities associated with a plurality of smart devices. Tasks associated with the device capabilities may be determined, and game actions may be associated with the tasks based on the device capabilities.

### BRIEF DESCRIPTION OF THE DRAWINGS

The accompanying drawings, which are incorporated in and constitute a part of this specification, illustrate embodiments and together with the description, serve to explain the principles:

FIG. 1 is a block diagram of an example system;

FIG. 2A is a block diagram of an example system;

FIG. 2B is a block diagram of an example system;

FIG. 3A is an example directory;

FIG. 4 is a flowchart of an example method;

FIG. 5 is a flowchart of an example method;

FIG. 6 is a flowchart of an example method; and

FIG. 7 is a block diagram of an example computing device.

### DETAILED DESCRIPTION

Before the present techniques are disclosed and described, it is to be understood that this disclosure is not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” or “example” means “an example of” and is not intended to convey an indication of a preferred or ideal embodiment. “Such as” is not used in a restrictive sense, but for explanatory purposes.

Disclosed are components that can be used to perform the disclosed content analysis and storage techniques. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present systems and methods may be understood more readily by reference to the following detailed description of preferred embodiments and the examples included therein and to the Figures and their previous and following description.

As will be appreciated by one skilled in the art, the content analysis and storage techniques may take the form of an entirely hardware embodiment, an entirely software embodiment, or an embodiment combining software and hardware aspects. Furthermore, the content analysis and storage techniques may take the form of a computer program product on a computer-readable storage medium having computer-readable program instructions (e.g., computer software) embodied in the storage medium. More particularly, the present content analysis and storage techniques may take the form of web-implemented computer software. Any suitable computer-readable storage medium may be utilized including hard disks, CD-ROMs, optical storage devices, or magnetic storage devices.

Embodiments are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

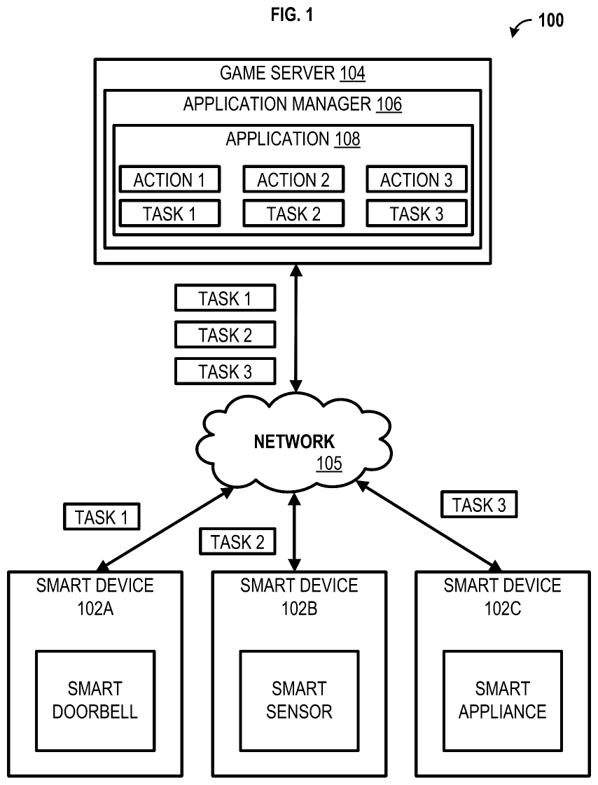

FIG. 1 shows an example system 100 in which the present methods and systems may operate. One skilled in the art will appreciate that provided herein is a functional description and that the respective functions can be performed by software, hardware, or a combination of software and hardware. The system 100 may facilitate content distribution and management. The content may comprise any media such as a video game, an online game, an e-sports game, an online video conference, combinations thereof, and the like. The content may be associated with an application 108.

The system 100 may comprise a plurality of client devices 102A-C in communication with a computing device, such as a game server 104, through a network 105. For example, each smart device of the plurality of smart devices 102A-C may be an internet of things (IoT) device, a smart appliance, a sensor, a computing device such as a computer, gaming console, smart phone, camera, server, or any other device capable of receiving, sending, processing, and/or outputting data. While only smart devices 102A, 102B, and 102C are shown, it is to be understood the system 100 may comprise any number of smart devices. Likewise, while only a single game server 104 is shown, it is to be understood that the system 100 may comprise any number of game servers. The plurality of smart devices 102A-C may be in communication with the game server 104 through a network 105. The network 105 may comprise any telecommunications network such as the Internet or a local area network. Other forms of communications can be used such as wired or wireless telecommunication channels, for example. The network 105 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. The communication protocols may be universal, generally applicable protocols or they may be game provider specific.

Each smart device of the plurality of smart devices 102A-C may send and receive data to and from each other and the game server 104 through the network 105. Each smart device of the plurality of smart devices 102A-B may be associated with at least one device capability. Each smart device of the plurality of smart devices 102A-C may be configured to send and receive capability information indicating the at least one device capability. The capability information may indicate hardware or software parameters associated with the smart device such as a class of device (e.g., a camera, a doorbell, a window sensor) or other capabilities of the smart device. Similarly, the capability information may indicate performance parameters associated with the smart device. For example, the capability information may indicate one or more capabilities associated with the respective smart device. For example, the one or more capabilities may comprise audio in (microphone), audio out (speakers), 2D capture capability (e.g., red-green-blue or “RGB” camera), streaming capabilities, graphics capabilities, video chat capabilities, 3D/Skeletal/Gesture capabilities (e.g., WiFi motion, RGB camera, other sensor technology), lean back experience (e.g., video playback on a TV screen), smart light capabilities, gesture capabilities (e.g., gyroscope/accelerometer configurations), network capabilities, graphics processing capabilities, resource availability, network connection status, response time, processing speed, channel capacity, latency, bandwidth, throughput, relative efficiency, scalability, power consumption, compression ratios, size and weight, environmental impact, transistor counts, signal quality, combinations thereof, and the like. For example, a first smart device 102A of the plurality of smart devices 102A-C may be a smart doorbell and be associated with a device capability such as entry/exit detection and/or an image capture capability. For example, a second smart device 102B of the plurality of smart devices 102A-C may be a motion sensor and be associated with a motion detection capability. For example, a third smart device 102C of the plurality of smart devices 102A-C may be a smart refrigerator and may be associated with a label scanning capability. Each smart device of the plurality of user deices 102A-C may send and receive data to and from the game server 104.

The game server 104 may be any computing device which may receive, process, distribute, and/or output data. The game server 104 may comprise an application manager 106 configured to manage (e.g., run) an application 108 (e.g., a game). For example, the application 108 may comprise a game such as a video game. The video game may be associated with one or more game actions. For example, the one or more game actions may comprise wielding a game object, opening a virtual door, moving a virtual character, or similar game actions as will be appreciated by one skilled in the art. For example, by executing a game action, a player may advance through the game.

The game server 104 may receive, from the plurality of smart devices 102A-C, a plurality of device capabilities. For example, upon launching the application, the game server 104 may query at least one smart device of the plurality of smart devices 102A-C so as to determine at least one device capability associated the at least one smart device. The at least one smart device may respond to the query by sending at least one device capability to the game server 104, or alternatively may indicate that the smart device is not configured with a device capability.

The game server 104 may receive the plurality of device capabilities and determine, based on the plurality of device capabilities, one or more tasks. For example, the smart device 102A (e.g., the smart doorbell), may be associated with a task such as ringing the smart doorbell. For example, the smart device 102B (e.g., the motion sensor) may be associated with a task such as detecting motion (e.g., the motion of a user detected by the motion sensor). For example, the smart device 102C (e.g., the smart refrigerator), may be associated with a task such as scan a label. The application manager 106 may associate the plurality of device capabilities with the one or more tasks.

The application manager 106 may associate the one or more game actions with the one or more tasks. For example, a first game action may be to enter a virtual house. For example, the first game action may comprise an avatar (e.g., a game character) entering the virtual house. The associated task may be to open a physical door at a premises of one of the players. As such, because the smart device 102A is associated with open/close detection capability, the application manager 106 may associate the smart device 102A with the task. The user may be prompted to execute the task by receiving a message on a computing device (e.g., a smart phone, computer, gaming console) associated with the user. For example, in order to complete the task, a user may ring the doorbell and/or open or close the door in order to complete the task. The doorbell may send an open/close indication to the game server 104, the application manager 106 may mark the task complete, and in response, may execute the game action of entering (e.g., moving an avatar into) the virtual house.

Similarly, a second game action may be to advance an avatar across a virtual space (e.g., move the game character across a room towards a locked chest). An associated task may be to detect, via a motion sensor, a person walking across a field of view of the motion sensor. As such, based on the motion detection capabilities associated with the smart device 102B (e.g., the motion sensor), the application manager 106 may associate the smart device 102B with the task of detecting motion. For example, a user may be prompted (as described in greater detail below) to walk across a space (e.g., a room, a porch, a driveway) where the user may be detected by the motion sensor. The user may be prompted to execute the task by receiving a message on a computing device (e.g., a smart phone, computer, gaming console) associated with the user.

Similarly, a third game action may be the avatar opening (e.g., unlocking) the locked chest. The associated task may to be input an alphanumerical combination (e.g., via a user interface such as a touchscreen or other user interface) into a smart appliance such as a smart refrigerator, smart thermostat (e.g., the Nest®), or a security system. The user may be prompted to execute the task by receiving a message on a computing device (e.g., a smart phone, computer, gaming console) associated with the user. Upon inputting the alphanumerical combination (e.g., a “code”), and thereby completing the task, the avatar may be caused to unlock and open the locked chest.

As non-exhaustive examples, the game action may comprise one or more of wielding and/or exchanging a game object, executing and/or exchanging a power-up, executing and/or exchanging a broadcast of video data and/or audio data. The game object may be, for example at least one of: a weapon (e.g., a sword, a hammer, a gun, a slingshot, rocket launcher, a spear, a bow and arrow, a saw, a bomb, a grenade, a bore), a vehicle (e.g., a car, a truck, a plane, a bus, a jeep, a truck, a spaceship, a boat, a submarine, a helicopter, a drone), or any other object featured in a game (e.g., a flag, an animal, a game token). A person skilled in the art will appreciate that the aforementioned are merely exemplary and explanatory and are not limiting. The game action may be, for example, a power-up and/or exchanging the power-up. The game action may comprise a broadcast of video data and/or audio data.

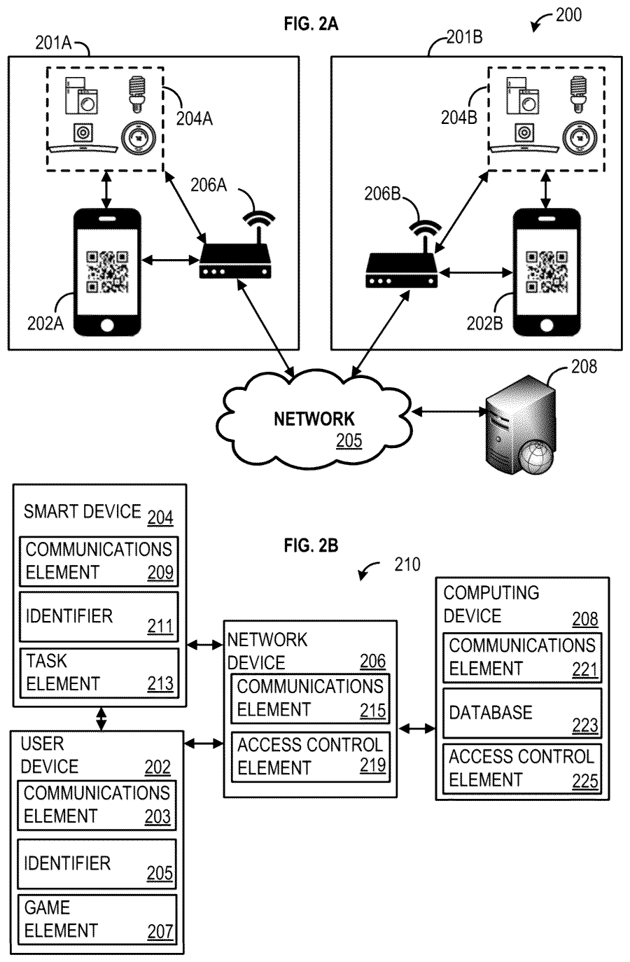

FIG. 2A shows an example system 200. The system 200 may be distributed across one or more premises 201A and 201B. For example, a first premises 201A of the one or more premises may comprise a first user device 202A, a first one or more smart devices 204A, and a first network device 206A. The first user device 202A may be a smartphone, a computing device, a gaming console, a tablet, a laptop, a desktop, a television, a streaming media stick, combinations thereof, and/or the like. The first network device 206A may be an access point, a router, a gateway device, combinations thereof, and the like. The first network device 206A may be configured to provide a first local area network (LAN) associated with the first premises 201A. The various devices of the first premises 201A may be configured to communicate with each other via the first LAN.

The first one or more smart devices 204A may comprise one or more internet of things (IoT) devices. The one or more smart devices may be headless IoT devices or they may not be headless IoT devices. A headless device may refer to an IoT device which does have a monitor, graphical user interface, or other peripheral devices. As a “headless” IoT device may not have an interface, the user device may be configured to communicate with the network device on behalf of the headless IoT device. As another example, the IoT device may not be a “headless” device. That is, the IoT device may be computing device comprising a screen/display, or other interface such as a mobile device or any other Internet-capable device having a screen/display (e.g., for a graphical user interface). For example, and as seen in FIG. 2A, the first one or more smart devices 204A may comprise a smart refrigerator, a smart washing machine, a smart lightbulb, a smart camera/motion sensor, a smart thermostat, combinations thereof, and the like. A person skilled in the art will appreciate that while only five smart devices are shown, the first one or more smart devices 204A may comprise any number and/or any type of smart devices as is known in the art.

Similarly, a second premises 201B of the one or more premises may comprise a second user device 202B, a second one or more smart devices 204B, or no smart devices, and a second network device 206B. The second user device 202B may be a smartphone, a computing device, a gaming console, a tablet, a laptop, a desktop, combinations thereof, and/or the like. In the event the second premises 201B does not comprise an smart devices, users might engage in a representation of the game that is only on their user device (202B) because they don't have any smart devices, in which case there would be a virtual representation of the smart devices rather than a physical representation, e.g. the grandparents could type in a code on their user device rather than on a smart refrigerator The second network device 206B may be an access point, a router, a gateway device, combinations thereof, and the like. The second network device 206B may be configured to provide a second local area network (LAN) associated with the second premises 201B. The various devices of the second premises 201B may be configured to communicate with each other via the second LAN.

The second one or more smart devices 204B may comprise one or more internet of things (IoT) devices. The one or more smart devices may be headless IoT devices or they may not be headless IoT devices. A headless device may refer to an IoT device which does have a monitor, graphical user interface, or other peripheral devices. As a “headless” IoT device may not have an interface, the user device may be configured to communicate with the network device on behalf of the headless IoT device. As another example, the IoT device may not be a “headless” device. That is, the IoT device may be computing device comprising a screen/display, or other interface such as a mobile device or any other Internet-capable device having a screen/display (e.g., for a graphical user interface). For example, and as seen in FIG. 2A, the second one or more smart devices 204B may comprise a smart refrigerator, a smart washing machine, a smart lightbulb, a smart camera/motion sensor, a smart thermostat, combinations thereof, and the like. A person skilled in the art will appreciate that while only five smart devices are shown, the first one or more smart devices 204B may comprise any number and/or any type of smart devices as is known in the art.

The system 200 may comprise a game server 208. The game server 208 may be the game server 104. The game server 208 may host an application such as a game. The game server 208 may be configured to send and receive data. For example, the game server 208 may be configured to communicate with either or both of network device 206A and 206B via the network 205. The network 205 may be the network 105 of FIG. 1.

The game server 208 may be configured to facilitate game play. Game play may refer to sending, receiving, generating, or otherwise processing game data. For example, the game server 208 may receive, from at least one user device (e.g., the user device 202A and/or the user device 202B), a request to launch a game.

One or more queries may be sent. For example, based on receiving the request to launch the game, the game server 208 may send one or more queries. For example, the game server 208 may send the one or more queries to the first or second user devices 202A and/or 202B, and/or the one or more smart devices 204A and/or 204B. The one or more queries may be configured to determine one or more smart devices associated with the one or more user devices. For example, the one or more user devices may determine, based on one or more smart device identifiers the one or more smart devices. The one or more smart device identifiers may comprise an combination of letters and/or numbers such as, for example, an IP address, a MAC address, a manufacturer ID, device type, make, model, or configuration. The one or more user devices may register the one or more smart devices. For example, the one or more smart devices may send the one or more smart device identifiers to the game server 208. For example, the game server 208 may comprise a database associating, for example, the first user device 202A with the first one or more smart devices 204A and further associating the second user device 202B with the second one or more smart devices 204B. The game may comprise (e.g., be associated with) one or more game actions as described herein. For example, a first game action may be to move an avatar across a room. For example, a second game action may be to open a locked chest on the other side of the room.

In the case that the one or more queries are sent, one or more responses may be sent and/or received. For example, in the case that the one or more queries are sent to at least one of the user devices 202A and/or 202B, the at least one user device may respond to the query. For example, the first user device 202A may respond to the query with a response comprising information indicating at least one device type of the first one or more smart devices 204A. For example, the first user device 202A may indicate that the first user device 202A is associated with a smart camera/motion sensor. Similarly, the second user device 202B may respond to the query indicating that the first user device 202B is associated with a smart refrigerator. The responses may indicate device capabilities associated with the smart camera/motion sensor and the smart refrigerator. For example, the response from the first user device 202A may indicate that the smart camera/motion sensor is capable of capturing images and/or detecting motion. Similarly, the response from the second user device 202B may indicate that the smart refrigerator is capable of receiving user inputs via a user interface and is also configured with a universal purchase code (UPC) scanner.

One or more corresponding tasks may be determined. The one or more corresponding tasks may be determined based on the one or more device capabilities. For example, based on receiving the device capabilities, the game server 208 may determine corresponding tasks. The device capabilities may be associated with the corresponding tasks. For example, the game serve 208 may associate the device capabilities with the corresponding tasks. For example, based on receiving the response from the first user device 202A that indicates the smart camera/motion sensor is equipped with image capture/motion detection technology, the game server may determine an image capture task (e.g., capture an image of a QR code on a cell phone) and/or a motion detection task (e.g., detect motion in a field of view of the smart camera/motion sensor. Similarly, based on receiving the response from the second user device 202B indicating the smart refrigerator is equipped with a user interface and a UPC scanner, the game server 208 may determine a code entry task (e.g., enter a numerical code into the user interface) and/or a UPC scanning task (e.g., scan a UPC code from a product in the smart refrigerator). Additionally and/or alternatively, the task may be a virtual representation of the physical task. For example, the game server 208 may require a museum guest to use a given clue to figure out a specific food item and find the item in the museum café, where physical kitchen represents museum café. For example, a participant without required device capability may navigate to virtual museum café using a remote to find and click on a food item to unlock a next clue, while a participant with a required device capability may find a physical food item in a kitchen and hold the physical food item up to camera or UPC scanner to unlock next clue.

The one or more tasks may be associated with the one or more game actions. For example, the game server 208 may associate the one or more tasks with the one or more game actions. For example, the game server 208 may associate the motion detection task with the game action of moving the avatar across the room. For example, based on the association between the motion detection task and the avatar movement game action, the game server 208 may send a first message to the first user device 202A. The first message may comprise at least one first prompt. The at least one first prompt may be configured to cause a first player to traverse a field of view of the smart camera/motion sensor so as to trigger a motion alarm. The smart camera/motion sensor may send the alarm to the first user device 202A and the first user device 202A may relay the alarm to the game server. The smart camera/motion sensor may be a connected device (e.g., an IoT device) and may send the alarm to the game server 208.

The motion detection task may be determined to be complete. For example, the game server 208, based on receiving the motion alarm, may determine that the motion detection task is complete. For example, based on determining the motion detection task is complete, the game server 208 may cause an avatar to advance across a room. For example, the game server 208 may update graphics data associated with the game and send the updated graphics data to the user device 202A. For example, the user device 202A may output the updated graphics data so as to visually depict the avatar moving across the room.

Similarly, based on the association between the code entry task and the unlocking game action, the game server 208 may send a second message to the second user device 202B. The second message may comprise at least one second prompt. The at least one second prompt may be configured to cause a second player to enter a code into the user interface of the smart refrigerator and/or scan a UPC of a product via the UPC scanner of the smart refrigerator. Based on entry of the code and/or scanning of the code, the smart refrigerator may send a code scanning indication and/or code entry indication to the second user device 202B and the second user device 202B may relay the indication to the game server 208. Additionally and/or alternatively, the smart refrigerator may be an IoT device and may send the indication to the game server 208.

It may be determined that the code entry/scanning task is complete. For example, it may be determined that the code entry/scanning task is complete based on receiving the indication that the code has been entered and/or the product has been scanned. For example, the game server 208, based on receiving the indication that the code has been entered and/or the product has been scanned, may determine that the code entry/scanning task is complete. Based on determining the code entry/scanning task is complete, the game server 208 may cause an avatar to open a locked chest. For example, the game server 208 may update graphics data associated with the game and send the updated graphics data to the user device 202A. The user device 202A may output the updated graphics data so as to visually depict the avatar opening the locked chest.

Game play may be facilitated. For example, the game server 208 may be configured to facilitate game play. For example, the game server 208 may receive data from, for example, any of the user devices and/or smart devices of systems 100 or 200. For example, the game server 208 may process the data and output game data. For example, the game server 208 may send, to the user devices 202A and/or 202B the game data. For example, after completing a task the first user device 202A may send the indication that the task has been completed to the game server 208. For example, the game server 208 may update the game data based on the task being completed and the corresponding game action being executing. For example, the game server 208 may distribute the updated game data to the user device 202B via the network 205.

FIG. 2B shows an example system 210. The system 210 may comprise some or all of the components of the system 200. The system 210 may comprise a smart device 204 (e.g., any one of the first one or more smart devices 204A), a user device 202 (e.g., any of the first user device 202A and/or the second user device 202B), a network device 206 (e.g., any of the first network device 206A and/or the network device 206B), and a computing device 208 (e.g., the game server 208).

The user device 202 may have a communications element 203. The communications element 203 may be used to send and/or receive communications to/from other devices of the system 210. The communications element 203 may include one or more wireless interfaces, such as an 802.11 radio, a ZigBee radio, a Z-Wave radio, or a Bluetooth™ radio.

The user device 202 may be associated with a user device identifier 205. The user device identifier 205 may be associated with, in addition to the user device 202, a user of the user device 202. The user device identifier 205 may be any identifier, token, character, string, or the like, for differentiating one user or computing device from another user or computing device. For example, the user device identifier 205 may comprise a MAC address. The user device identifier 205 may identify a user or computing device as belonging to a particular class of users or computing devices. The user device identifier 205 may comprise information relating to the user device 202 such as a manufacturer, a model or type of device, a service provider associated with the user device 202, a state of the user device 202, a locator, and/or a label or classifier. Other information may be represented by the user device identifier 205. The user device identifier 205 may be assigned to the user device 202 by the network device 206 and/or the computing device 208.

The user device 202 may comprise a game element 207. The game element may be configured to send, receive, generate, and/or otherwise process data (e.g., the game data). For example, the game element 207 may be configured to receive the one or more queries from the game server 208 (e.g., the computing device 208). The game element may be configured to send data indicating the completion of a task to the computing device 208. The game element may be configured to process graphics, for example so as to render graphics associated with the one or more game actions. The game element 207 may be configured as an AR/VR element.

The smart device 204 may comprise a communication element 209, a smart device identifier 211, and a task element 213. The task element 213 may be any piece of hardware or software configured to facilitate the completion of a task. For example, in the case the smart device 204 comprises a smart camera, the task element 213 may comprise the hardware and software configured to capture an image. For example, in the case the smart device 204 is a motion sensor, the task element 213 may comprise the motion sensing component. For example, in the case the smart device 204 is a door or window sensor, the task element may comprise the hardware and software configured to detect the opening and/or closing of the door. The smart device 204 may also be repurposed from its normal function to a game specific function. For example, a door lock may have a default keycode that the game participant already knows, but the game could set a temporary keycode to be entered upon solving a clue.

The smart device identifier 211 may be associated with the smart device 204. The smart device identifier 211 may be any identifier, token, character, string, or the like, for differentiating one user or computing device from another user or computing device. For example, the smart device identifier 211 may comprise a MAC address. The smart device identifier 211 may identify a smart device as belonging to a particular class. For example, the smart device identifier 211 may identify the smart device as an IoT device, for example, a smart doorbell, a smart camera, a smart motion sensor, a smart thermostat, a smart appliance such as a refrigerator, washing machine, over, dishwasher, smart light bulb, or the like. The smart device identifier 211 may comprise information relating to the smart device 204 such as a manufacturer, a model or type of device, a service provider associated with the smart device 204, a state of the smart device 204, a locator, and/or a label or classifier. Other information may be represented by the device identifier 211. The smart device identifier 211 may be assigned to the smart device 204 by the network device 206 and/or the computing device 208.

The communications element 215 may be used to send and/or receive communications to/from other devices of the system 201. The communications element 215 may include one or more wireless interfaces, such as an 802.11 radio, a ZigBee radio, a Z-Wave radio, or a Bluetooth™ radio. The network device 206 may be an access point, a router, a gateway device, combinations thereof, and the like. The network device 206 may be configured to provide a first local area network (LAN) to the system 210.

The access control element 217 may be a secure repository of the network device 206 used to store routing table(s), a configuration identifier for each configured IoT device, a Media Access Control (“MAC”) address(es) for each configured IoT device, network credentials, combinations thereof, and the like.

The computing device 208 may comprise a communication element 221. The communications element 221 may be used to send and/or receive communications to/from other devices of the system 201. The communications element 221 may include one or more wireless interfaces, such as an 802.11 radio, a ZigBee radio, a Z-Wave radio, or a Bluetooth™ radio. The computing device 208 may be a computer, a server, a gaming console, combinations thereof, and the like.

The computing device 208 may comprise a task element 223. The task element 223 may comprise hardware and/or software components and may be configured to determine one or more tasks. The computing device 208 may determine the one or more tasks based on the one or more device capabilities associated with, for example, the smart device 204. For example, the smart device identifier 211 may indicate the smart device 204 is a door sensor. The smart device 204 may send the smart device identifier 211 to the computing device 208, and the task/action element 223 may determine that, based on the smart device identifier 211, the smart device 204 comprises a door sensor. Based on determining the device type of the smart device 204, the task/action element 223 may determine a device capability associated with the smart device 204. For example, the task/action element may determine the door sensor has a capability of detecting when a door is open or closed. Based on the device capability, the task/action element 223 may determine a task such as, for example, open the door or close the door. Similarly, if the smart device 204 is a motion sensor, the task may be to detect a motion. Similarly, if the smart device 204 is a smart refrigerator, the task may be to scan a product code. Similarly, if the smart device 204 is a smart lightbulb, the task may be to turn the lightbulb on or off.

The computing device may comprise a game element 225. The game element 225 may comprise hardware and/or software components and may be configured to send, receive, store, generate, and/or otherwise process data. For example, the game element 225 may be configured to send/or receive one or more messages. For example, the game element 225 may be configured to determine game data and update the game data. The game element may be configured to determine one or more game actions associated with a game. The one or more game actions may comprise wielding a game object, opening a virtual door, moving a virtual character, or similar game actions as will be appreciated by one skilled in the art. For example, by executing a game action, a player may advance through the game. The game element 225 may, based on the one or more device capabilities, associate the one or more tasks with the one or more game actions. For example, the game element 225 may receive, from the task element 223, the one or more tasks associated with the smart device 204, and may determine, based on the game data, the one or more game actions. Based on the association between the one or more tasks and the one or more game actions, the computing device 208 may send, to the smart device 204 and/or the user device 202, a message. The message may comprise a data packet or the like. The message may comprise a prompt, a command, an instruction, or the like. The message may be configured to cause an action either by a user of the user device 202 or the smart device 204 itself. For example, the characteristics available on each smart device (e.g. door or window sensor has open/close state) would be used to synthesize a list of possible tasks, and that the game could be adapted from a static script (e.g. door must be opened, but it could be a virtual door or a physical door depending on what smart devices are available). Additionally and/or alternatively, the game script itself could be dynamically generated based on available smart devices (e.g. add a door open/close step to the puzzle since the physical environment has a door open/close sensor). Additionally and/or alternatively, a different game could be chosen depending on the physical environment (e.g. escaping from cabin in an avalanche vs stopping a nuclear launch in a secret underground lair).

For example, the computing device 208 may send, to the user device a 202 instructing a user of the user device to present, to a smart camera a QR code and capture an image of the QR code via the smart camera, or capture an image of object via computer vision. Similarly, the message may instruct the user of the user device to capture an image of the user by the smart camera. Upon capturing the image of the QR code and/or the user, the smart camera may send a message to the computing device 208 (e.g., the game element 225) an indication that the task has been completed. Based on the indication that the task has been completed, the game element 225 may execute the associated game action. For example, if the smart device 204 comprises a smart door sensor, the task may be to open the door. The user may open the door, and the smart door sensor may relay to the computing device 208 that the door has been opened. Based on the indication that the door has been opened, the game element may update the game data such that graphics data is updating to show an avatar opening a virtual door. The updated game data may be relayed to the user device 202 (or any other of the any number of user devices that may be involved in the game).

As another example, the smart device 204 may comprise a smart light. The game element 225 may determine a game action is to solve a puzzle involving Morse code, for example entering a combination of letters into a virtual lock so as to open a virtual treasure chest. Based on a device identifier associated with the smart light bulb, and the device capabilities of the smart light bulb, the task element 223 may determine the smart light bulb is configured to execute the task. Based on an association between the user device 202 and the smart light bulb (e.g., a product registration or the like), the game element 225 may send, to the user device 202, a first message with instructions. The instructions may instruct the user to “Crack the Code!” Meanwhile, the game element may send to the smart light bulb a second message. The second message may be configured to cause the smart light bulb to turn on and off (e.g., blink) according to the puzzle involving Morse code. If the user associated with the user device is able to discern the Morse code output by the smart light bulb, the user may, via a user interface, enter the code and thereby cause a third message to be sent. The third message may be sent to the computing device 208. The third message may indicate the task (e.g., discerning the Morse code) has been completed. Based on the task being complete, the game element 225 may execute the game action. For example, the game element 225 may update graphics data to depict an avatar entering the combination into the virtual lock and opening the virtual treasure chest.

The computing device may comprise a database 227. The database 227 may be configured to receive, send, store, generate, and/or otherwise process data. For example, the database 227 may be configured to store one or more identifiers. For example, the database 227 may be configured to store one or more user device identifier associated with one or more user devices, one or more smart device identifiers associated with one or more smart devices, and one or more network device identifiers associated with one or more network devices. The computing device 208 may associate the various identifiers. For example, the computing device 208 may store, in the database 227 an association between the user device identifier 205 and the smart device identifier 211. The association may be based on a preconfigured association or may be determined based on, for example, a message received from the user device 202. For example, the user device 202 may register the smart device 204. The registration may be accomplished by any means, for example, by scanning the identifier 211.

The database 227 may be configured to store game data in a game directory. The game data may comprise one or more game actions, one or more player profiles, graphics information, combinations thereof, and the like. The game data may comprise one or more associations between

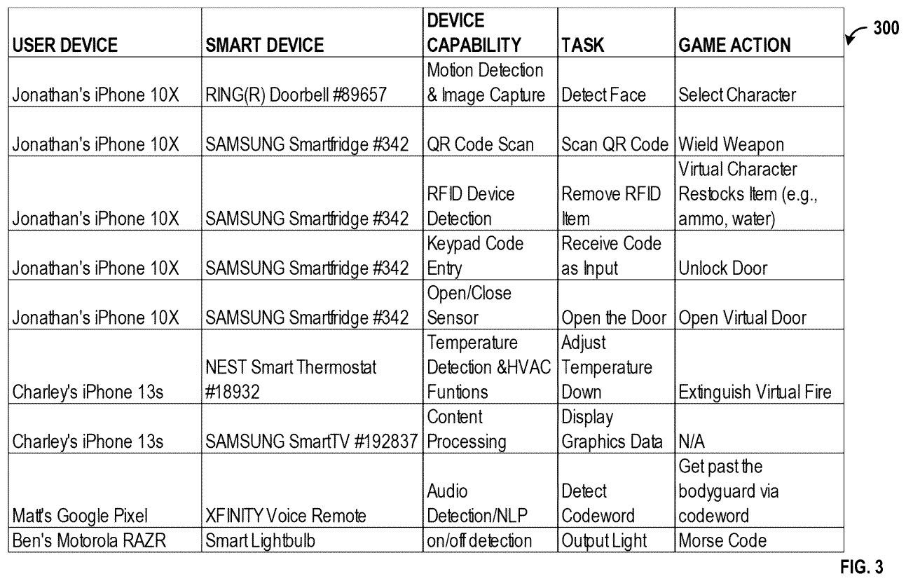

FIG. 3 shows an example game directory 300. The game directory 300 may comprise game data. The game data may comprise one or more user devices (e.g., one or more user device identifiers), one or more smart devices (e.g., one or more IoT device identifiers), one or more device capabilities associated with the one or more smart devices, one or more tasks, one or more game actions associated with a game, combinations thereof, and the like and associations thereof. The one or more user device identifiers may indicate an association with one or more users. The one or more user device identifiers may indicate a make and/or model of the one or more user devices. The one or more smart device identifiers may indicate a manufacturer, a model, and one or more functionalities and/or configurations. For example, a user may register a smart device and during registration, may indicate one or more device capabilities associated with the smart device. For example, in game directory 300, The SAMSUNG Smart Refrigerator is associated with a QR code scan device capability, an RFID capability, a door open/close sensing capability, and a keypad capability (e.g., similar to the keypad found on microwaves).

The game directory 300 may comprise one or more tasks. The one or more tasks may comprise one or more player tasks to complete (e.g., open or close the refrigerator door, smile at the smart doorbell, bring a user device within a distance of a smart device, take a picture of an object etc.). The one or more tasks may be associated with one or more game actions. The one or more game actions may comprise or more actions taking place within a game (e.g., open or close a virtual dungeon cell, wielding a weapon, cause some other action to be undertaken by, for example, an avatar, a game character, or the like).

The following is a list of non-limiting examples given for explanatory and exemplary purposes. For example, the game may require a participant to figure out that next clue is in museum basement. A default participant may use a remote to navigate to a museum basement after figuring out where to go, while a participant with basement and presence sensor technology such as WiFi motion physically goes to basement in house (since house is the museum in the game). The game may require a specific physical gesture/pose for a museum security guard to unlock a vault. For example, a default participant may use a remote to manipulate an avatar, while a participant with Bluetooth connected gamepad experiences more sophisticated avatar manipulation, while a participant with gesture/skeletal tracking support (camera, 3D tracking sensor, WiFi motion) expresses gesture directly.

For example, if the game requires a participant to navigate to a specific painting on wall of museum, a default participant may select a step by step path to the target painting shown on screen using remote, while a participant with WiFi motion or camera physically selects location on wall of room where painting would be located. For example, if the game requires a participant to find an electronic device left behind by a mysterious museum guest, a default participant may find the device on a screen using remote, while a participant with 5+ Bluetooth LE equipped devices (Alexa, Google Mini, Comcast Settop, etc.) may use a mobile device with Bluetooth LE running companion app to physically find target device (get within 3 feet using signal strength of Bluetooth LE). For example, if the game requires a participant to converse with another museum guest to solve a riddle, a default participant may use text entry to converse, while a participant with a microphone (push-to-talk voice remote or far field voice device) may speak with the museum guest directly.

For example, if the game requires a guest to recall or decipher a light (color, intensity) sequence to enter next code, a default participant may watch the light sequence on screen and may enter a sequence on a screen using remote, while a participant with LED light strip(s) or smart light bulbs watches light sequence (game controls lights) in room/home and then enters sequence on screen or second screen device. For example, if the game requires a guest to use given clue to figure out a specific food item and find the item in the museum café, a default participant may navigate to a virtual museum café using a remote to find and click on a food item to unlock a next clue, while a participant with a camera in a kitchen (and ideally additional augmentation such as smart refrigerator to know what food items are available) may adapt the clue to food items present in kitchen/refrigerator and that participant finds physical food item and holds up to camera to unlock next clue.

For example, if the game requires a participant to enter a code to unlock a door, a default participant may enter the code on a screen using remote to unlock virtual door, while a participant with smart door lock may physically enter the code in door lock to unlock the physical door. For example, if the game requires a participant to figure out a tune a janitor was whistling to impersonate the janitor and get past the guard, a default participant may select the tune from a list on a screen, while a participant with microphone whistles tune directly into the microphone.

For example, if the game requires a participant to choose a correct color hat in museum gift shop, a default participant may select the hat on a screen, while a participant with camera with AR/VR may physically put on the correctly colored hat and scan the hat. For example, if the game requires a code derived from quantities of items in a museum (how many chairs in a room may be a first digit, how many tables in the room may be a second digit, etc.), a default participant may navigate around a museum space to count quantities, while a participant who performed a pre-game walk around with second screen device may count quantities in physical (home) environment.

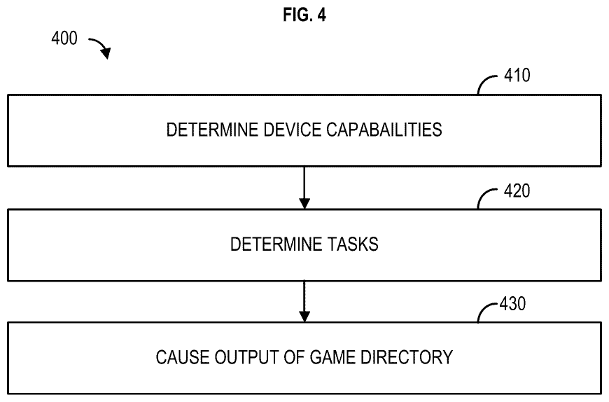

FIG. 4 shows an example method 400. The method 400 may be carried out on any one or more devices. For example, the method 400 may be carried out on any one or more devices described herein such as those in FIG. 1. At step 410, one or more device capabilities associated with one or more smart devices may be determined. The one or more device capabilities may be determined by a computing device. The one or more smart devices may be one or more client devices. The one or more smart devices may be a plurality of user devices. The one or more smart devices may comprise one or more internet of things (IoT) devices. For example, the one or more smart devices may comprise a smart doorbell, a smart camera, a smart motion sensor, a smart TV, a smart remote, a smart thermostat, a smart appliance such as a refrigerator, washing machine, oven, dishwasher, smart light bulb, a voice assistant (e.g., near-field or far field), combinations thereof, or the like. The one or more device capabilities may be associated with hardware and/or software configures or parameters of the one or more smart devices. For example, the smart doorbell may comprise a motion sensor, and image capture device, internet connectivity, and an alert functionality. For example, the smart remote may comprise an audio detection device, internet connectivity, and software configured for natural language processing (NLP) or other similar techniques. For example, the smart refrigerator may comprise an optical code scanning device (e.g., a UPC code scanner, a QR code scanner, and the like), an open/close sensor configured to detect when a door to the refrigerator is open or closed, and an RFID system configured to detect the presence of, and additional information about (e.g, expiration date) of one or more items within the smart refrigerator.

Determining the one or more device capabilities may comprise receiving one or more messages. The one or more messages may be sent by one or more user devices and/or the one or more smart devices. For example, a user device of the one or more user devices may register a smart device of the one or smart devices and/or, the one or more smart devices may be configured to self-register. The one or more messages may indicate the one or more device capabilities. The one or more messages may be received by the computing device in response to an initiation of a game. The one or more messages may comprise one or more identifiers. For example, a smart device of the one or more smart devices may be associated with an identifier of the one or more identifiers. The identifier may identify a device type, class, manufacturer, configuration, combinations thereof, and the like. The computing device may determine at least one device capability associated with at least one smart device based on the identifier. For example, the identifier may indicate the associated smart device is a door sensor. For example, the identifier may indicate the associated smart device is a smart camera. For example, the identifier may indicate the associated smart device is a smart refrigerator, a smart light bulb, or any other type of device.

At step 420, one or more tasks may be determined. The one or more tasks may be determined based on the one or more device capabilities. The one or more tasks may be associated with the one or more smart devices based on the respective capabilities of each smart device of the one or more smart devices. Associating the one or more tasks with the one or more smart devices may comprise forming a logical association (e.g., a mapping) in a game directory. For example, the computing device may determine a first smart device has a door open/close sensing capability and may associate the door open/close sensing capability with a door open/close task. Thus, the first smart device (e.g., a smart refrigerator) is also logically associated with the door open/close task in the game directory. For example, the door open/close task may comprise opening or closing a door.

One or more game actions may be determined. The one or more game actions may be determined based on the one or more tasks. For example, the computing device may determine a first smart device with a door open/close sensing capability is associated with a door open/close task and may determine a door open/close game action. For example, the computing device may determine a second smart device with an image capture capability (e.g., a smart camera, a smart doorbell, a smart motion sensor, etc.) is associated with an image capture task and may determine an image capture game action (e.g., discern the identity of a hooded or masked figure). For example, the computing device may determine a smart device with a code scanning capability (e.g., a smart refrigerator) is associated with a code scanning task and may determine an item identification game action (e.g., unwrapping a mystery gift). For example, the computing device may determine a smart device with a light output capability (e.g., a smart light bulb) is associated with a light output task and may determine a code entry game action. For example, the computing device may determine a smart device with an audio output capability (e.g., a smart speaker) is associated with an audio output task (e.g., outputting a sound) and may determine an instruction delivery game action (e.g., a first avatar may deliver instructions to a second avatar).

At step 430, a game directory may be output. The game directory may comprise one or more of: one or more user device identifiers, one or more smart device identifiers, one or more device capabilities, one or more tasks, one or more game actions, and associations therebetween. For example, the one or more smart devices may be associated with the one or more game actions. Associating the one or more smart devices with the one or more game actions may comprise determining a logical association such as, for example, based on the one or more device capabilities. For example, a smart door sensor smart device may be associated with a door open game action (e.g., causing an avatar to open a virtual door). Similarly, a UPC scanning smart device may be associated with a code entry game action such as unlocking a locked treasure chest.

A game may be output. For example, the game may comprise tone or more game actions. A first message may be sent. For example, the first message may be sent to at least one smart device of the one or more smart devices. The first message may comprise one or more data packets. The first message may comprise a prompt, instruction, alert, combinations thereof, and the like. For example, the first message may be configured to cause a user to execute a task associated with the smart device. For example, the first message may instruct the user associated with the smart device to interact with the smart device (e.g., capture an image, scan a product code, open or close a door, etc.). The first message may be configured to cause the receiving smart device to execute a task. For example, if the smart device is a smart light bulb, the first message may be configured to cause the smart light bulb to turn on and off (e.g., blink) at a certain frequency or in accordance with a pattern or like (e.g., blink according to Morse code).

It may be determined that a first smart device of the one or more smart devices does not possess a first device capability associated with a first task. For example, the first task may comprise a scanning task. A user device associated with the first smart device that does not possess the first device capability may be determined. A second message may be sent to the user device associated with the smart device that does not possess the first device capability. The second message may be configured to cause the user to interact with the user device so as to execute, for example, the scanning task by scanning a code with a code-scanning component of the user device (e.g., a camera). If the first task comprises, for example, opening or closing a door, the second message may be configured to cause the user device to output (e.g., via an interface) a virtual door which the user may open or close by interacting with the interface.

An indication that a task has been completed may be received. For example, the computing device may receive, from at least one smart device of the one or more smart devices and/or at least one user device, the indication that a task has been completed. A game action may be executed based on the completion of the task.

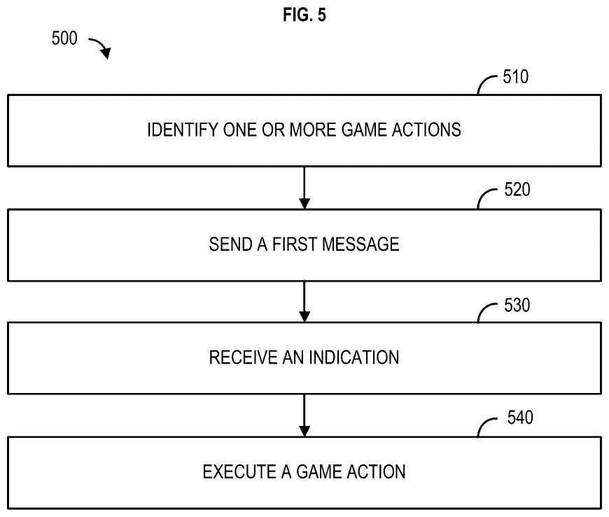

FIG. 5 shows an example method 500. The method 500 may be carried out on any one or more devices. For example, the method 500 may be carried out on any one or more devices described herein such as those in FIG. 1. At step 510, one or more game actions associated with a game may be determined. The one or more game actions may be determined based on one or more smart device capabilities and/or one or more tasks associated with a plurality of smart devices as described herein. For example, the computing device may determine a first smart device with a door open/close sensing capability is associated with a door open/close task and may determine a door open/close game action. For example, the computing device may determine a second smart device with an image capture capability (e.g., a smart camera, a smart doorbell, a smart motion sensor, etc.) is associated with an image capture task and may determine an image capture game action (e.g., discern the identity of a hooded or masked figure). For example, the computing device may determine a smart device with a code scanning capability (e.g., a smart refrigerator) is associated with a code scanning task and may determine an item identification game action (e.g., unwrapping a mystery gift). For example, the computing device may determine a smart device with a light output capability (e.g., a smart light bulb) is associated with a light output task and may determine a code entry game action. For example, the computing device may determine a smart device with an audio output capability (e.g., a smart speaker) is associated with an audio output task (e.g., outputting a sound) and may determine an instruction delivery game action (e.g., a first avatar may deliver instructions to a second avatar). For example, based on the one or more game actions, at least one smart device may be designated to execute at least one task. For example, the at least one smart device may comprise a smart doorbell and therefore a task such as ringing the smart doorbell may be determined, an associated game action may comprise opening a virtual door. For example, the smart device may comprise a smart motion sensor therefore a task such as detecting motion (e.g., the motion of a user detected by the motion sensor) may be determined and the associated game action may comprise moving a character across a room. For example, the smart device may be configured for gesture recognition (e.g., raising/waving a hand, pointing to a specific region of a field of view or a screen etc.) For example, the smart device may comprise a smart refrigerator and therefore a task such as scanning a label and/or determining a product code (e.g., via UPC scanner) and the associated game action may comprise unlocking a locked treasure chest.

At step 520, at least one first message may be sent to the at least one smart device. For example, the computing device may send at least one first message to the at least one smart device. For example, the at least one first message may be sent either from the computing device directly to the smart device or from the computing device to a user device associated with the smart device and then relayed from the user device to the smart device or sent directly from the computing device to the smart device. For example, the at least one first message may be a data packet or the like. For example, the at least one first message may be configured to cause the at least one smart device to execute the at least task. For example, the at least one first message may be configured to cause the at least one smart device to execute a task of the one or more tasks (e.g., receive an input, activate the at least one smart device capability). For example, the smart refrigerator may activate its UPC scanner and determine a scanned UPC. For example, if the smart device is a smart light bulb, the at least one first message may be configured to cause the smart light bulb to turn on and off (e.g., blink) in Morse code. For example, the first message may be configured to activate an image capture capability of a smart doorbell.

At step 530, an indication that the at least one task has been completed may be received. For example, the indication that the at least one task has been completed may be received in an at least one second message. For example, the at least one second message may be a data packet or the like and the indication may comprise a field entry in the data packet. For example, the at least one second message may be sent from the user device and received by the computing device. For example, the at least one second message may be received by the computing device directly from the smart device. For example, if the at least one task is a code scanning task, the smart refrigerator may, upon scanning a UPC code, send the indication to the computing device. Similarly, the smart lightbulb may send an indication that the Morse code signal has been output. Similarly, the user device may detect the Morse via image capture technology and relay it to the computing device.

At 540, the at least one game action may be executed. For example, the at least one game action may be executed based on the indication that the at least one task has been completed. Executing the game action may comprise one or more of wielding and/or exchanging a game object, executing and/or exchanging a power-up, executing and/or exchanging a broadcast of video data and/or audio data. The game object may be, for example at least one of: a weapon (e.g., a sword, a hammer, a gun, a slingshot, rocket launcher, a spear, a bow and arrow, a saw, a bomb, a grenade, a bore), a vehicle (e.g., a car, a truck, a plane, a bus, a jeep, a truck, a spaceship, a boat, a submarine, a helicopter, a drone), or any other object featured in a game (e.g., a flag, an animal, a game token).

The gaming environment may be updated. For example, the gaming environment may be updated based on executing the game action. Updating the gaming environment may comprise sending update game information to one or more user devices. Updating the gaming environment may comprise updating graphics data and sending, to the one or more user devices the updated graphics data. For example, the updated graphics data may depict avatar executing the game action (e.g., opening a door, wielding a weapon, unlocking a treasure chest, etc.).

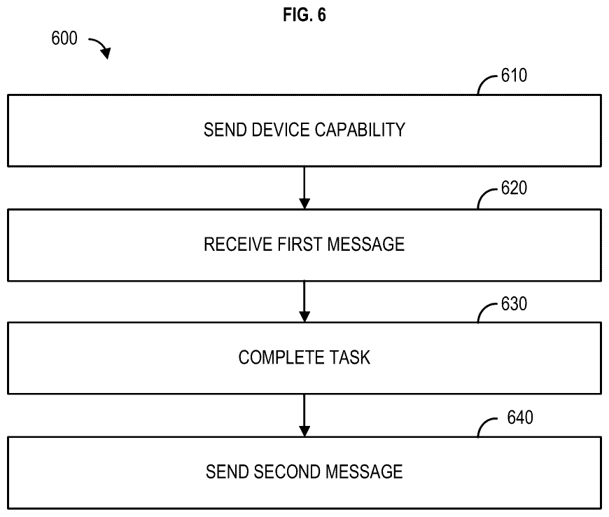

FIG. 6 shows an example method 600. The method 600 may be carried out on any one or more devices. For example, the method 600 may be carried out on any one or more devices described herein such as those in FIG. 1. At step 610, a plurality of user devices may be determined. The plurality of user devices may be determined based on a game directory as described herein indicating a plurality of smart devices associated with a plurality of tasks. Each task of the plurality of tasks may be associated with one or more game actions of the plurality of game actions. The user device may comprise a smart phone, a computer, a gaming console, or the like. The at least one smart device may comprise one or more internet of things (IoT) devices. For example, the at least one smart devices may comprise a smart doorbell, a smart camera, a smart motion sensor, a smart thermostat, a smart appliance such as a refrigerator, washing machine, oven, dishwasher, smart light bulb, or the like. The user device may determine a smart device identifier associated with the smart device. The smart device identifier may be associated with the at least one device capability. For example, the smart device identifier may identify a device type, a device class, a device manufacturer, a device configuration, combinations thereof, and the like. The at least one device capability may be associated with one or more hardware or software components of the smart device. For example, the at least one device capability may be associated with a sensor. For example, the at least one device capability may be a code scanning capability associated with a UPC code scanner, a door open/close sensing capability, or a light output capability.

At 620, a first message may be sent. The first message may be associated with a first task. The first task may be associated with a game action. The first message may indicate a first game action of a plurality of game actions of a game. The first task may be associated with a game. The first message may be configured to cause the first task to be executed. For example, the first message may comprise a prompt. The first message may comprise a graphic. The first message may comprise an instruction. For example, the prompt may instruct a user to interact with the at least one smart device. For example, based on the device capability, if the smart device is a motion sensor, the task may be to detect a motion. Similarly, if the smart device is a smart refrigerator, the task may be to scan a product code. Similarly, if the smart device is a smart lightbulb, the task may be to turn the lightbulb on or off.

At 630, a second message may be received. For example, the user device or a smart device may send the second message to the computing device. The second message may indicate the task has been completed. The second message may be received, for example, from the at least one smart device. Additionally and/or alternatively, the second message may be received and/or generated by a user interface of the at least one smart device. For example, upon detecting the motion, the motion sensor may send the indication to the user device. Similarly, if the smart device is a smart refrigerator, upon scanning the UPC code, the smart refrigerator may send a code scanned indication to the user device. Similarly, if the smart device is a smart lightbulb, the smart lightbulb may send a light output indication to the user device. Additionally and/or alternatively, a user may interact with the user device and thereby generate the indication that the task has been completed. Additionally and/or alternatively, the one or more smart devices may send the second message directly to the computing device. For example, if the smart device is configured to internet connectivity and communication, the smart device may send the second message.

At step 640, a third message may be sent. The third message may be sent to the first user device or another user device of the plurality of user devices. The third message may be sent based on the indication that the first task has been completed. For example, based on receiving the indication that the first task has been completed, the computing device may determine, based on the plurality of game actions associated with the game, a second task. The second task may be another task of the plurality of tasks associated with the game.

One or more graphics may be output. For example, the one or more graphics may be output based on the at least one first message and/or the at least one second message. For example, the at least one first message may be configured to cause output of a graphic on the user device. For example, the at least one second message may be configured to cause the computing device to update graphics data and relay the updated graphics data one or more additional user devices participating the game. The user device and/or the one or more additional user devices may comprise, for example, a smart phone, a computer, laptop, a gaming console, an AR device, a VR device, combinations thereof, and the like.

Premises data may be determined. For example, the user device may be associated with a user device identifier, a network device identifier, a service provider identifier, or the like. The premises data may comprise demographic data, geographic data, architectural data, combinations thereof, and the like. Premises data may be used to dynamically generate a game script, for example knowing that there is a basement could be mapped to a dungeon or underground lair, or knowing the actual layout of the house could be used to generate an escape scenario that is actually based on the house itself rather than a virtual location such as a museum, submarine, etc.

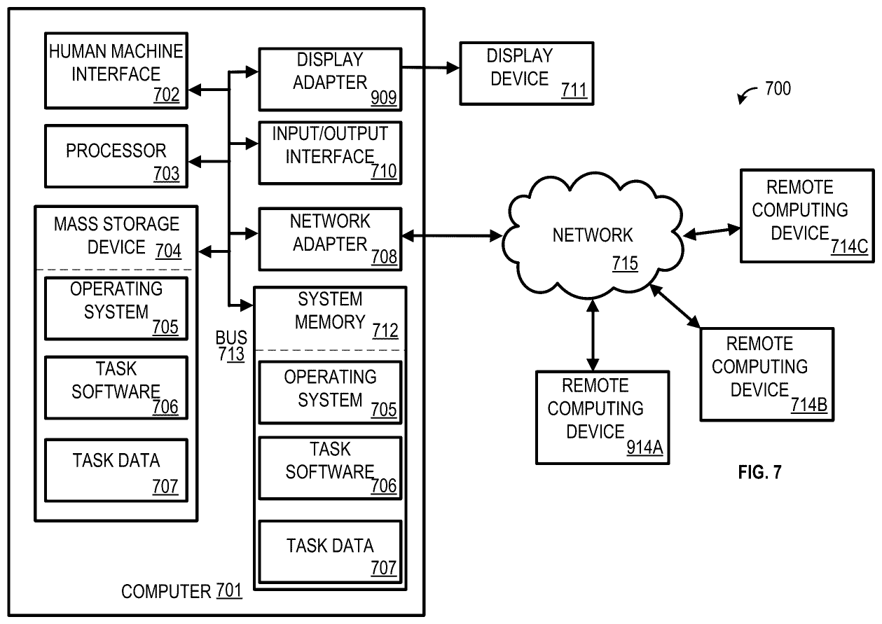

The above described disclosure may be implemented on a computer 601 as illustrated in FIG. 7 and described below. By way of example, game server 104 of FIG. 1 can be a computer as illustrated in FIG. 7. Similarly, user device 102 may be a computer as illustrated in FIG. 7. Likewise, the game server 104 or the user device 102 may be a remote computing device (e.g., remote computing devices 714A, 714B, or 714C) of FIG. 7. FIG. 7 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program elements, being executed by one or more computers or other devices. Generally, program elements comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program elements can be located in both local and remote computer storage media including memory storage devices.

Further, one skilled in the art will appreciate that the systems and methods disclosed herein can be implemented via a general-purpose computing device in the form of a computer 701. The components of the computer 701 can comprise, but are not limited to, one or more processors 703, a system memory 712, and a system bus 713 that couples various system components including the one or more processors 703 to the system memory 712. The system can utilize parallel computing.

The system bus 713 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the one or more processors 703, a mass storage device 704, an operating system 705, computing task software 706, computing task data 707, a network adapter 708, the system memory 712, an Input/Output Interface 710, a display adapter 709, a display device 711, and a human machine interface 702, can be contained within one or more remote computing devices 714A, 714B, 714C at physically separate locations, connected through buses of this form, in effect implementing a fully distributed system.

The computer 701 typically comprises a variety of computer readable media. Example readable media can be any available media that is accessible by the computer 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as the computing task data 707 and/or program elements such as the operating system 705 and the computing task software 706 that are immediately accessible to and/or are presently operated on by the one or more processors 703.

The computer 701 can also comprise other removable/non-removable, volatile/non-volatile computer storage media. By way of example, FIG. 7 illustrates the mass storage device 704 which can facilitate non-volatile storage of computer code, computer readable instructions, data structures, program elements, and other data for the computer 701. For example and not meant to be limiting, the mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program elements can be stored on the mass storage device 704, including by way of example, the operating system 705 and the computing task software 706. Each of the operating system 705 and the computing task software 706 (or some combination thereof) can comprise elements of the programming and the computing task software 706. The computing task data 707 can also be stored on the mass storage device 704. The computing task data 707 can be stored in any of one or more databases known in the art. Examples of such databases comprise, DB2®, Microsoft® Access, Microsoft® SQL Server, Oracle®, mySQL, PostgreSQL, Mongo, Cassandra, and the like. The databases can be centralized or distributed across multiple systems.

The user or device can enter commands and information into the computer 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 703 via the human machine interface 702 that is coupled to the system bus 713, but can be connected by other interface and bus structures, such as a parallel port, game port, an IEEE 1394 Port (also known as a Firewire port), a serial port, or a universal serial bus (USB).

The display device 711 can also be connected to the system bus 713 via an interface, such as the display adapter 709. It is contemplated that the computer 701 can have more than one display adapter 709 and the computer 701 can have more than one display device 711. For example, the display device 711 can be a monitor, an LCD (Liquid Crystal Display), an augmented reality (AR) display, a virtual reality (VR) display, a projector, combinations thereof, and the like. In addition to the display device 711, other output peripheral devices can comprise components such as speakers (not shown) and a printer (not shown) which can be connected to the computer 701 via the Input/Output Interface 710. Any step and/or result of the methods can be output in any form to an output device. Such output can be any form of visual representation, including, but not limited to, textual, graphical, animation, audio, tactile, and the like. The display device 711 and computer 701 can be part of one device, or separate devices.

The computer 701 can operate in a networked environment using logical connections to one or more remote computing devices 714A, 714B, 714C. By way of example, a remote computing device can be a gaming system, personal computer, portable computer, smartphone, a server, a router, a network computer, a peer device or other common network node, and so on. Logical connections between the computer 701 and a remote computing device 714A, 714B, 714C can be made via a network 716, such as a local area network (LAN) and/or a general wide area network (WAN). Such network connections can be through the network adapter 708. The network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components reside at various times in different storage components of the computing device 701, and are executed by the one or more processors 703 of the computer. An implementation of the selective computing task software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program elements, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

What is claimed is:

1. A method comprising:
determining at least one device capability associated with at least one smart device;
determining at least one task associated with the at least one device capability; and
causing, based on the association between the at least one task and the at least one device capability, output of a game directory comprising an association between the at least one smart device and the at least one game action.

2. The method of claim 1, wherein the at least one smart device comprises at least one of: an internet of things (IoT) device, a smart phone, a smart appliance, a camera, a sensor, a computing device, a network device, a television, or an audio device.

3. The method of claim 1, wherein the game directory further comprises at least one association between at least two of: the at least one device capability, the at least one smart device, the at least one task, or the at least one game action.

4. The method of claim 1, further comprising receiving, from the at least one smart device, an indication that the at least one task has been executed.

5. The method of claim 1, further comprising:
determining, based on the at least one device capability and the at least one task, that no smart device is configured to execute the at least one task; and
determining at least one user device configured to execute the at least one task.

6. The method of claim 1, wherein the at least one task comprises interacting with an internet of things (IoT) device, a security device, an image capture device, an audio capture device, a smart home device, a smart appliance, or a utility.

7. The method of claim 1, further comprising receiving, from the at least one smart device, an indication that the at least one task has been completed.

8. A method comprising:
identifying, based on at least one device capability associated with at least one smart device, at least one game action and at least one task;
sending, a first message configured to cause the at least one smart device to execute the at least one task;
receiving an indication that the at least one task has been completed; and
based on receiving the indication that the at least one task has been completed, executing the at least one game action.

9. The method of claim 8, wherein the at least one smart device comprises at least one of: an internet of things (IoT) device, a smart phone, a camera, a sensor, a computing device, a network device, a television, or an audio device.

10. The method of claim 8, further comprising:
updating, based on the indication that the at least one task has been completed, graphics data; and
sending, to at least one user device associated with the at least one smart device, the updated graphics data.

11. The method of claim 8, wherein the at least one task comprises interacting with an internet of things (IoT) device, a security device, an image capture device, an audio capture device, a smart home device, a smart appliance, or a utility.

12. The method of claim 8, wherein executing the at least one game action comprises causing at least one of: a character movement, a scene movement, achieving a task, opening a game object, closing a game object, wielding a game object.

13. The method of claim 8, wherein the first message configured to cause the at least one smart device to execute the at least one task is configured to cause the at least one smart device to at least one of: open a communication session, activate a piece of hardware, or activate a piece of software.

14. The method of claim 8, further comprising:
updating, based on the indication that the at least one task has been completed, game progress data; and
sending, to at least one user devices associated with the at least one smart device, the updated game process data.

15. The method of claim 8, further comprising:
determining at least one second task;
determining the at least one smart device is not configured to execute the at least one second task; and
designating at least one second smart device to execute the at least one second task.

16. The method of claim 8, further comprising:
based on receiving the indication that the at least one task has been completed, determining a second game action associated with a second task, wherein the second task is associated with a second smart device; and
based on an association between the second smart device and a user device, sending, to the user device a message associated with the second game action.

17. A method comprising:
determining, based on a game directory indicating a plurality of smart devices associated with a plurality of tasks, wherein each task of the plurality of tasks is associated with a game action of a plurality of game actions, a plurality of user devices;
sending, based on the game directory, to a first user device of the plurality of user devices, a first message indicating a first game action of the plurality of game actions;
receiving a second message indicating a first task associated with the first game action has been completed; and
sending, based on the game directory and the first task being completed, to a second user device, a third message indicating a second game action of the plurality of game actions.

18. The method of claim 17, wherein sending the first message to the first user device comprises determining, in the game directory, an association between the first user device and a first smart device of the plurality of smart devices.

19. The method of claim 17, wherein the plurality of smart devices comprises at least one of: an internet of things (IoT) device, a smart phone, a smart appliance, a camera, a sensor, a computing device, a network device, a television, or an audio device.

20. The method of claim 17, further comprising causing, based on the second message indicating the first task has been completed, output of an updated graphic associated with the first game action.
